(19) United States
(12) Patent Application Publication
(10) Pub. No.: US 2005/0028941 A1
(43) Pub. Date: Feb. 10, 2005

(54) Carpet film applicator

(76) Inventor: Bobby N. Flowers, Olathe, KS (US)

Correspondence Address: CHASE LAW FIRM L.C, 4400 COLLEGE BOULEVARD, SUITE 130, OVERLAND PARK, KS, 66211, US

(21) Appl. No.: 10/635,282

(22) Filed: Aug. 6, 2003

(51) Int. Cl. B44C 7/00

(52) U.S. Cl. 156/574; 156/579; 156/71

(57) ABSTRACT

An apparatus for applying a plastic film to a surface such as a carpet is provided which includes a handle, frame, film roll dispenser, guide bar, at least one roller and a trailing roller. The trailing roller supports the apparatus off of the roller to allow the apparatus to be pulled back against the stair to smooth the film against the front of the stair.

### BACKGROUND OF THE INVENTION

The present invention relates to an apparatus for applying a film to a floor surface and, more particularly, to an apparatus for applying a protective film to a carpet.

Polyethylene film has been used to provide protection for carpets and carpeted stairs. Typically the polyethylene has one side coated with a low-tack adhesive and comes in 24, 32 and 36-inch widths in rolls up to 1,000 feet long. Rolls are typically reverse wound so that the adhesive layer is on the outside of the roll. When the film is applied to a carpeted surface, the adhesive layer is applied to the carpet to hold the film in place.

Applying the film to a carpet must be done by manually unrolling the film on one's hands and knees or by using a single roller device with a handle. These methods prove difficult to apply the film without wrinkles and are not particularly suited to application on carpeted stairs.

### SUMMARY OF THE INVENTION

Accordingly, a carpet film applicator is provided which includes a handle, film roller holder and front and rear rollers to flatten and smooth the film on a carpeted surface. A front guide straightens the film to reduce wrinkling. A pair of side stair guides automatically actuate when applying the film to stairs to smoothly apply the film.

The carpet film applicator may be used to apply a smooth plastic film to a carpeted surface by pushing the applicator along the floor. For stairs, the side support wheels automatically deploy to support the film applicator. With the weight of the applicator off of the front and rear rollers, the applicator may be pushed back against a stair to pull the film tightly against the stair. Once the film is pushed against the front of the stair, the applicator is lowered onto its front and rear rollers.

### BRIEF DESCRIPTION OF THE DRAWINGS

FIG. 1 is a perspective view of the carpet film applicator shown in operation on a flat surface.

FIG. 2 is a front elevational view of the carpet film applicator.

FIG. 3 is a side elevational view of the carpet film applicator.

FIG. 4 is a side elevational view of FIG. 3 with the side support wheels deployed.

FIG. 5 is an enlarged perspective view of the carpet film applicator.

FIG. 6 is a perspective view of the carpet film applicator shown in operation on stairs.

FIG. 7 is a side elevational view of FIG. 4 shown on a stair.

### DETAILED DESCRIPTION

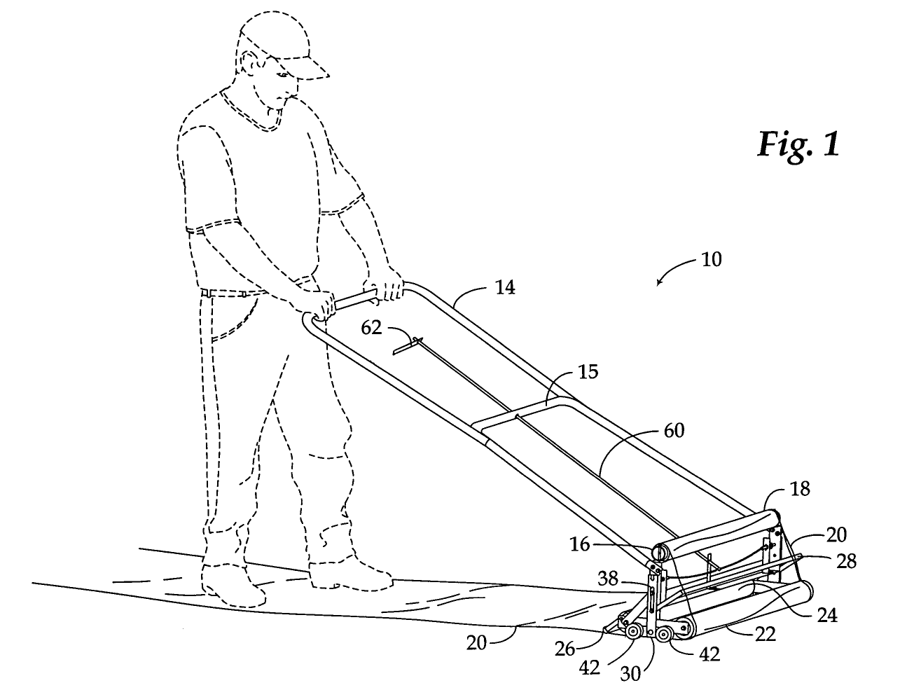

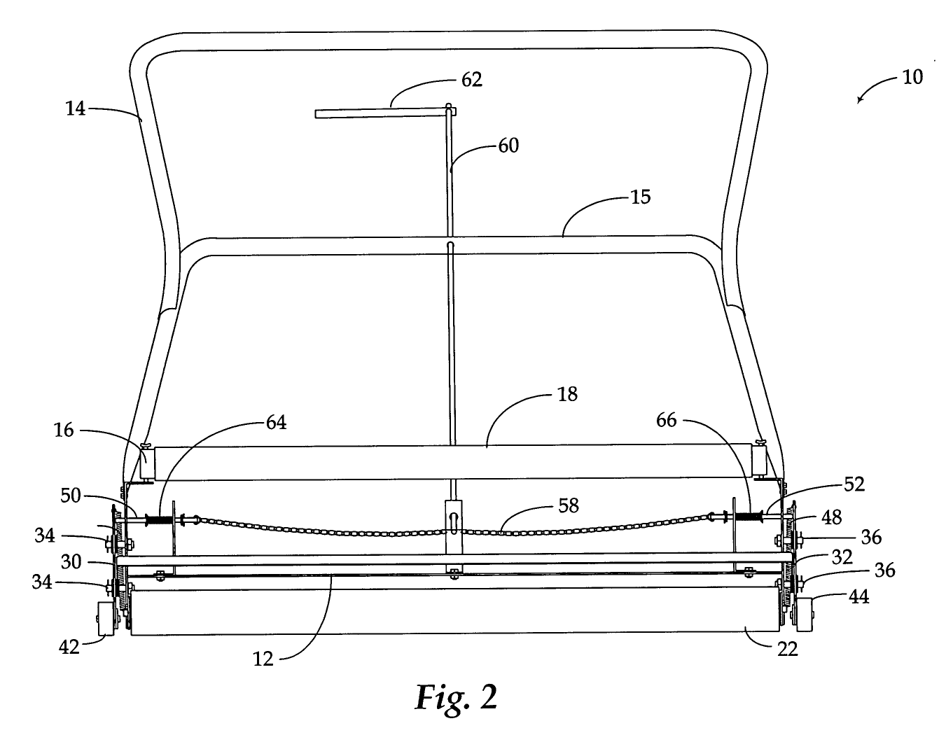

Referring to FIGS. 1 and 2, the carpet film applicator of the present invention is generally indicated by reference numeral 10. Film applicator 10 includes a frame 12, a push handle 14, an intermediate handle 15 and a film roll dispenser 16 which holds a film roll 18. The film roll dispenser 16 allows the film roll 18 to freely turn to dispense the plastic film 20. Plastic film 20 may be a polyethylene film with a low-tack adhesive backing to hold the film in place once it has been applied to a carpeted or other surface. Polyethylene film is widely used to protect carpeted surfaces because it is relatively thin and durable.

Front 22 and rear 24 rollers flatten the film 20 against the floor. A trailing roller 26 smoothes the film 20 and helps to tuck the film in against a stair. A front guide bar 28 helps keep the film 20 straight as it comes off roll 18 and is directed to roller 22. Guide bar 28 is bowed outwardly to help prevent wrinkles in the film 20 when it is dispensed from roll 18.

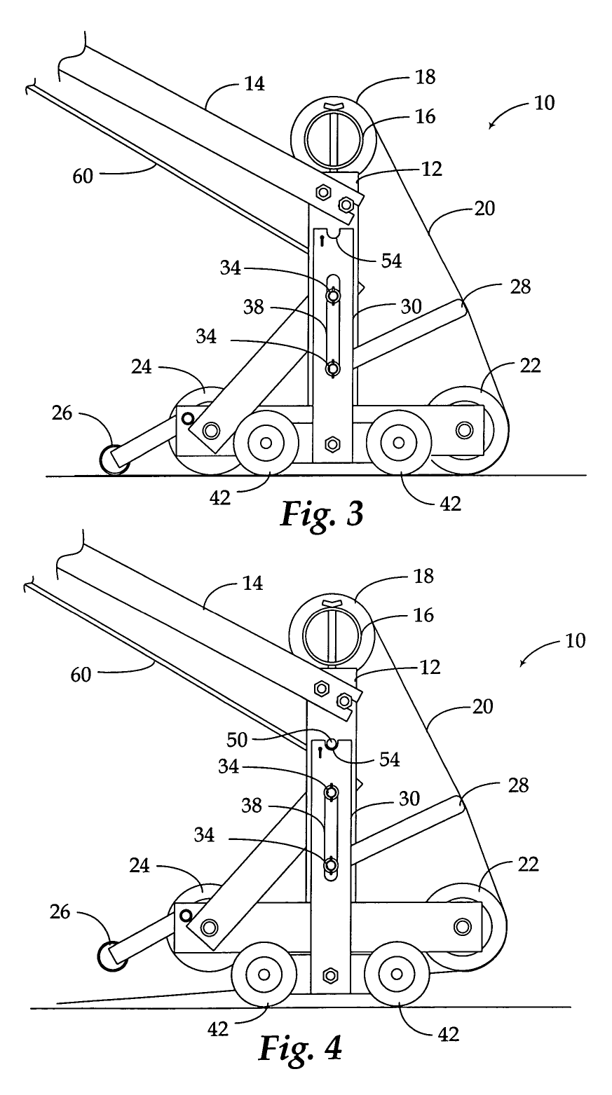

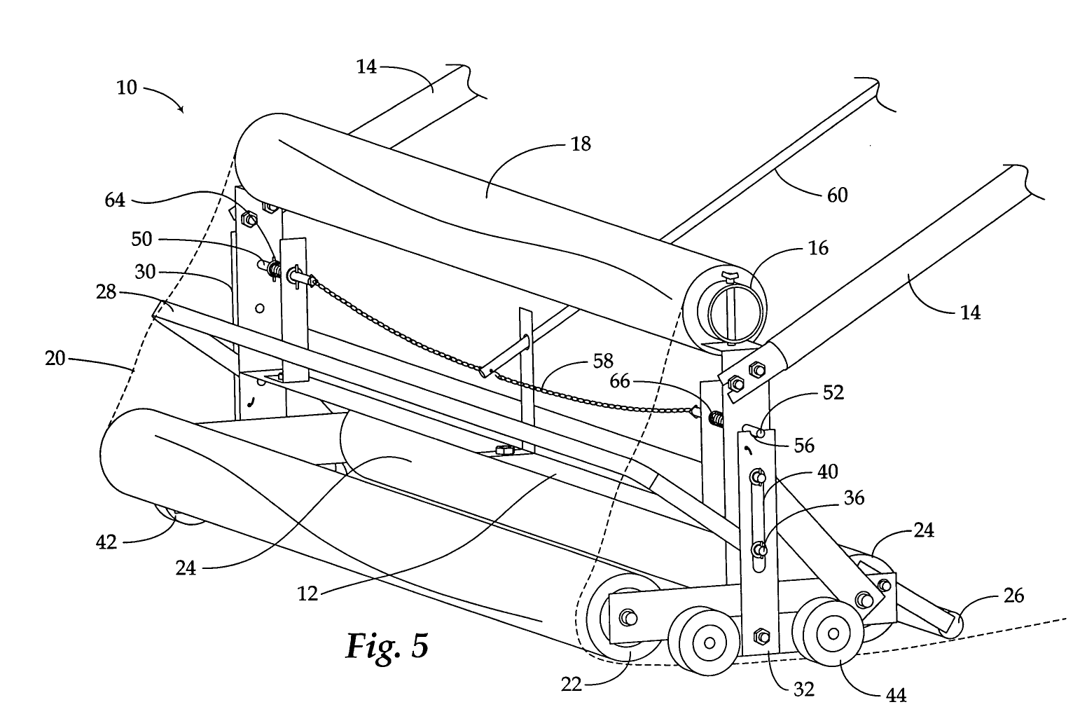

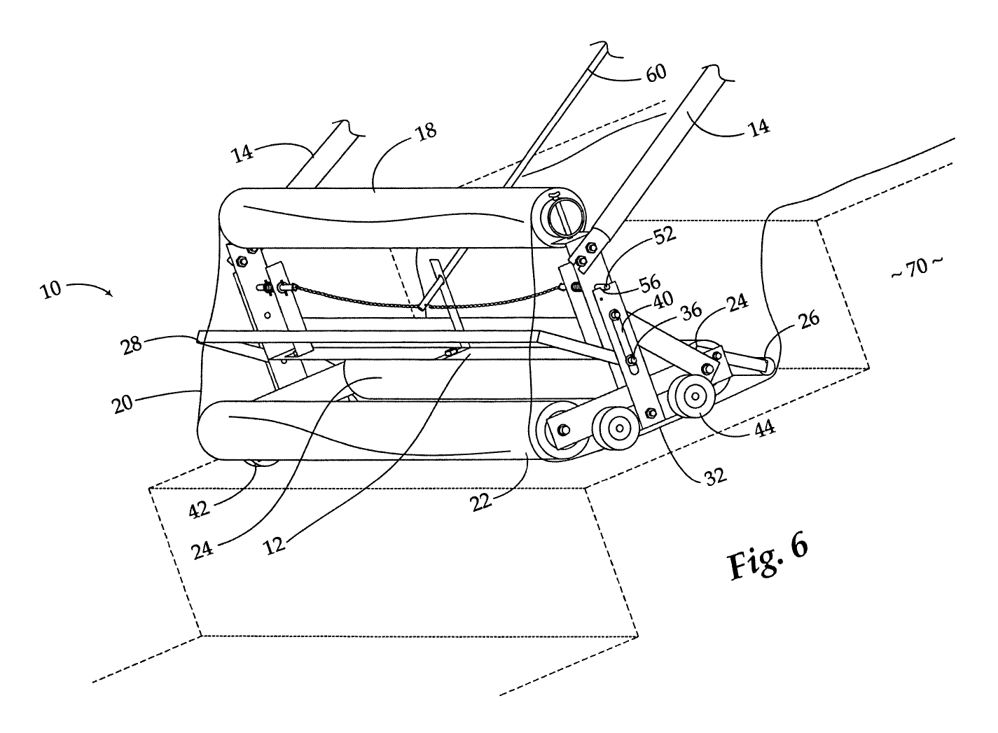

Referring to FIGS. 2-5, side stair guides 30 and 32 are each slidably attached to frame 12 by a pair of bolts or pins 34 and 36 through slots 38 and 40. The slots 38 and 40 allow the side stair guides 30 and 32 to move between a retracted position (FIGS. 3 and 5) and an extended position (FIG. 4). When in the retracted position, the bottom of wheels 42 and 44 of stair guides 30 and 32 are even with the bottoms of rollers 22 and 24. When the guides 30 and 32 are in the extended position, the guides 30 and 32 hold the rollers 22 and 24 above the floor.

A pair of latch springs 46 and 48, one on each side of applicator 10, are attached at one end to frame 12 and at the other end to side stair guides 30 and 32. When the latch springs 46 and 48 pull stair guides 30 and 32 down to the extended position, spring biased latch pins 50 and 52 extend an outboard of stair guides 30 and 32 and engage notches 54 and 56. A chain or cable 58 links latch pins 50 and 52 to a rod 60, with a release handle 62. Rotating the handle 62 tightens the chain 58 to pull the latch pins 50 and 52 inwardly against the bias of springs 64 and 66 to disengage latch pins 50 and 52 from notches 54 and 56.

Referring to FIGS. 1 and 3, when operating the carpet film applicator 10 on a flat surface, the operator pushes on the handle 14 to move the applicator 10. As the applicator 10 is pushed along, the plastic film 20 unrolls from film roll 18. The plastic film 20 travels over the guide bar 28 and under front 22 and rear 24 rollers and trailing roller 28 and onto the flat surface. The operator walks over the film 20 as it is smoothly applied.

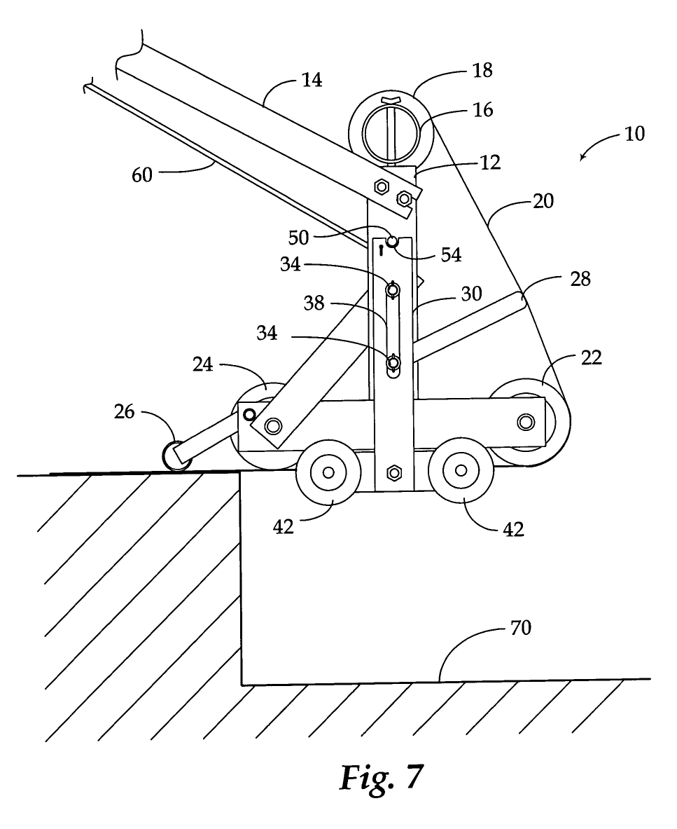

Referring to FIGS. 4-7, when the carpet film applicator 10 is operated on stairs 70, the front 22 and rear 24 rollers are extended over the edge of a stair such that only the trailing roller 26 is resting on the stair (See FIG. 7).

When the weight of applicator 10 is no longer on the side stair guide wheels 42 and 44, the latch springs pull the side stair guides 30 and 32 downwardly to the extended position. The spring biased latch pins 50 and 52 extend through notes 54 and 56.

The applicator 10 is then pushed over the edge of the stair 70 and lowered to rest on the next lower stair. The operator may grasp the intermediate handle 15 to help lower the applicator 10. The applicator 10 rests on the side stair guide wheels 42 and 44 which hold the applicator 10 off of the front 22 and rear 24 rollers and trailing roller 26. The applicator 10 may be pulled backward to tuck the film 20 into the nap of the stair 70. The operator then grasps the release handle 62 and turns the rod 60 to release the latch pins 50 and 52. When the latch pins 50 and 52 clear the notches 54 and 56, the applicator drops to the rollers 24 and 26 and the film 20 may now be applied to the next stair.

In the preferred embodiment, 24, 30 and 36-inch rolls of film may be applied, although other widths may also be applied. The front and rear rollers 22 and 24 may be constructed of rubber or other material to flatten the film 20. Handle 14 may be adjustable to allow for different positions depending on operator height or for use on stairs. Additionally, the applicator 10 may include a bar (not shown) which may be actuated by a lever (not shown) or by the handle 14, which is lowered behind the trailing roller 26 to tuck in the film against a stair.

It is to be understood that while certain forms of this invention have been illustrated and described, it is not limited thereto, except in so far as such limitations are included in the following claims and allowable equivalents thereof.

1. An apparatus for applying a film to a surface, said apparatus comprising:
a frame,
a handle fastened to said frame for pushing said apparatus,
a film roller dispenser secured to said frame for supporting a roll of film to be applied to a surface,
a guide bar secured to said frame in front of said film roller dispenser for smoothing said film as it is dispensed from said roll of film,
front and rear rollers secured to said frame below said guide bar and said film roll dispenser for flattening said film against said surface, and
a trailing roller secured to the rear of said frame behind said rear roller for supporting said apparatus as it is extended over a stair.

2. The apparatus as set forth in claim 1 further comprising an at least one stair guide having a frame slidably secured to said apparatus frame and at least one wheel secured to said stair guide frame, said stair guide slidable between a retracted position wherein said stair guide wheel is even with said apparatus rollers, and an extended position wherein said stair guide wheel extends below said apparatus rollers.

3. The apparatus as set forth in claim 2 further comprising a latch to releasably secure said stair guide in said extended position.

4. The apparatus as set forth in claim 3 further comprising a stair guide spring secured at a first end to said apparatus frame and at a second end to said stair guide frame.

5. An apparatus for applying a film to a surface comprising:
a frame,
a handle secured to said frame,
a film roll dispenser mounted to said frame for supporting a roll of said film to be applied to said surface,
a guide bar secured to said frame in front of said film roll dispenser for guiding and smoothing said film as it is dispensed from said roll of film,
front and rear rollers rotatably secured to said frame below said guide bar and said film roll dispenser for flattening said film against said surface as it is dispensed from said film roll over said guide bar and under said front and rear rollers,
a trailing roller secured to said frame behind said rear roller for supporting said apparatus as it is extended over a stair, and
a pair of stair guides slidably secured to said frame outboard of said rollers and generally perpendicular to a longitudinal axis of said rollers, each of said stair guides including an at least one wheel rotatably secured to said stair guide, said stair guide slidable between a retracted position wherein said at least one wheel is generally even with said rollers, and an extended position wherein said at least one wheel extends below said rollers, said stair guides releasably lockable in said extended position to support said apparatus.

6. An apparatus for applying a film to a surface comprising:
a frame,
a handle secured to said frame,
a film roll dispenser mounted to said frame for supporting a roll of said film to be applied to said surface,
a guide bar secured to said frame in front of said film roll dispenser for guiding said film as it is dispensed from said roll of film, and
an at least one roller rotatably secured to said frame generally below said film roll dispenser and said guide bar, said roller for flattening said film against said surface, as said film is dispensed from said roll of film and guided to said roller from said guide bar.

7. The apparatus as set forth in claim 6 further comprising a trailing roller rotatably secured to said frame behind said at least one roller for supporting said apparatus as said at least one roller is extended over a stair.

8. The apparatus as set forth in claim 7 further comprising a means to support said apparatus off of said at least one roller.

9. The apparatus as set forth in claim 8 wherein said support means includes a support frame slidably secured to said frame and slidable between a retracted position wherein said apparatus is supported by said at least one roller and an extended position wherein said apparatus is supported by said support frame.

10. The apparatus as set forth in claim 9 wherein said support means further includes an at least one wheel rotatably secured to said support frame and wherein said apparatus is supported by said wheel when said support means is in said extended position.

11. The apparatus as claimed in claim 9 further comprising a means to releasably lock said support means in said extended position.

12. The apparatus as claimed in claim 11 wherein said means to releasably lock said support means includes a latch pin movable between a released position when said support means is in said retracted position and a locked position when said support means is in said extended position, wherein said latch pin prevents movement of said frame from said extended position back to said retracted position.

13. The apparatus as claimed in claim 9 further comprising a means to tuck said film into a corner of a stairs.
